(19) United States
(12) Patent Application Publication
(10) Pub. No.: US 2025/0340163 A1
(43) Pub. Date: Nov. 6, 2025

(54) Folding Camping Apparatus

(71) Applicant: Rick Wise, Bend, OR (US)

(72) Inventor: Rick Wise, Bend, OR (US)

(21) Appl. No.: 19/048,792

(22) Filed: Feb. 7, 2025

Related U.S. Application Data
(60) Provisional application No. 63/550,883, filed on Feb. 7, 2024.

(51) Int. Cl. B60P 3/34

(52) U.S. Cl. CPC B60P 3/34

(57) ABSTRACT

A folding camper having a collapsed position wherein the roof and sides are lowered and having a deployed position wherein the roof is elevated above a body and sidewalls and front and rear walls are rotated to vertical positions. The body is positionable with the bed of a pickup truck. Actuators, which may be powered between elongated configurations and contracted configurations, may be engaged between the roof and the body to move the camper between the collapsed and deployed positions.

This application claims priority to U.S. Provisional Patent Application Ser. No. 63/550,883 filed on Feb. 7, 2024.

### BACKGROUND OF THE INVENTION

### 1. Field of the Invention

The invention herein disclosed relates generally to vehicle engageable camping structures. More particularly, it relates to a hard-sided camper which is removably engageable with the bed of a pickup truck which employs powered roof lifters easily deployable from a collapsed configuration to an enlarged configuration.

### 2. Prior Art

### Background of the Invention

Pickup trucks are highly popular vehicles primarily employed for work and for hauling materials in the bed of the pickup truck. However, because of the ability of such vehicles to haul significant weight in the rear-positioned bed, they are also widely used to hold campers and camping components which are removably engageable within the bed of the truck. Such allows the vehicle to be used for both work and for more enjoyable activities, such as camping. As such, many pickup truck owners who enjoy such camping activities will convert their pickup trucks either temporarily or permanently to campers.

Because of the popularity of camping, there are numerous pickup truck conversions which are readily commercially sold to pickup truck owners who wish to permanently or temporarily convert their pickup trucks to campers.

Permanent camping conversions generally include a self-contained fixed in position hard-sided camper unit, which is engaged with the bed of the pickup truck. Conventionally, such campers are equipped with home-type appliances, such as sinks, stoves, and refrigerators and the like. Such rigid or hard-sided campers have a substantially rigid shell structure which projects above a lower end which is located in the bed of the pickup truck. Where the truck is also used for work or hauling, such campers are conventionally adapted to slide into a removable engagement with the pickup truck bed.

However, such rigidly constructed campers, by projecting above the bed and cab of the pickup truck, will cause a significant reduction in fuel economy of the vehicle. Further, the extension of the camper above the truck bed and cab, imparts a significant raising of the center of gravity of the vehicle which can render it hard to handle on curves and in high winds.

While there exist collapsible and soft sided campers which engage with the bed of a pickup truck, such have their own issues. For example, soft sided campers are less than secure when camping in areas also occupied by animals such as bears.

With respect to the above, before explaining at least one preferred embodiment of the pickup truck engageable folding camper system herein, it is to be understood that the system invention is not limited in its application to the details of employment and to the arrangement of the components or the steps set forth in the following description or illustrated in the drawings. The various apparatus and operations of the herein disclosed pickup truck engageable folding camper system herein are capable of other embodiments, and of being practiced and carried out in various ways, all of which will be obvious to those skilled in the art once the information herein is reviewed.

Also, it is to be understood that the phraseology and terminology employed herein are for the purpose of description and should not be regarded as limiting. As such, those skilled in the art will appreciate that the conception upon which this disclosure is based may readily be utilized as a basis for other folding hard-sided campers which are removably mounted upon pickup trucks. It is important, therefore, that the embodiments, objects and claims herein, be regarded as including such equivalent construction and methodology insofar as they do not depart from the spirit and scope of the present invention.

### SUMMARY OF THE INVENTION

The disclosed device herein provides an easily-employed, collapsible, and hard-sided camper device. The camper device is removably engageable with the bed of a conventional pickup truck.

The camper device, as herein disclosed, may be actuated to move between a collapsed position minimizing wind resistance to the vehicle and an elevated or deployed position wherein it may be occupied for camping and the like. There are at least two and preferably four powered actuators.

By actuators herein is meant a powered component which has a retracted position and may be moved under electric or hydraulic or pneumatic power to an elongated or extended position, where an extendable arm moves away from a body of the component. The movement of the arm imparts a biasing force to whatever it is connected to in a direct of movement of the arm. Such, for example, may be an arm which is retracted within a cylinder and has an elongated position wherein the extendable arm has translated from the cylinder under power, such as electric or hydraulic or pneumatic power. The electric power can be provided by a motor engaged to a battery or power supply which rotates a geared engagement of the rod to the cylinder or hydraulic or pneumatic power which forces the rod away from the cylinder using power from pumps. At least two and preferably four actuators are preferred herein. The actuators have a first engagement point to a lower end of the camper device body and have a second engagement point to the roof of the camper device to impart a biasing force thereto when moving to an elongated position.

The sidewalls may be raised using a plurality of connections between the roof and two opposing sidewalls to provide a powered raising of the sidewalls to substantially vertical positions when the roof is raised. Such connections may include a track system at the upper end of the sidewalls engaged with the roof. Such connections may also include rotationally engaged members connected between the roof and the sidewalls.

The sidewalls are preferably formed of rigid material and are in a rotating connection at one end with a rigid body of the camper device, and may be tilted upward and substantially perpendicular to the plane of a slidably engaged roof or downward to a position substantially parallel to the plane of the roof. As noted, actuators, such as electric powered actuators or hydraulic cylinders operatively engaged between a lower end of the body of the device and the roof, are easily employed to provide a powered assist in raising the roof from the retracted position to the raised position. Through connections to the sidewalls, raising the roof will move the sidewalls to vertical positions.

Once the opposing sidewalls are rotated to their elevated positioning, substantially perpendicular to the plane of the roof, it may be locked in position by spring loaded locks which may be released by the pulling of a cable when the camper device is to be moved back to the compact retracted configuration.

A front wall which is in a rotating connection to the body and a rear wall, also in a rotating connection to the body, may be rotated to a substantially perpendicular positioning relative to the plane of the roof. An upper and lower door is operatively positioned in the rear wall to allow entry and exit from the formed interior cavity of the camper device while in the elevated or deployed positioning.

With respect to the above description, before explaining at least one preferred embodiment of the pickup truck engageable, folding camper system herein, it is to be understood that the invention is not limited in its application to the details of operation nor the arrangement of the components or the steps set forth in the following description or illustrations in the drawings. The various methods of implementation and operation of the camper herein are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other hard-sided folding camper systems which are engageable with a pickup truck, and for carrying out the several purposes of the disclosed string line support system. Therefore, that the objects and claims herein should be regarded as including such equivalent construction, steps, and methodology insofar as they do not depart from the spirit and scope of the present invention.

It is an object of this invention to provide a collapsible camper device configured for removable engagement with the bed of a truck or which may be positioned upon a trailer frame.

It is another object of this invention to provide such a camper device or system wherein the roof is load bearing in both the collapsed position and the elevated or deployed position.

It is a further object of this invention to provide such a camper system and device wherein powered actuators are engaged between the roof and body, which will raise the roof and concurrently raise the sidewalls.

These, together with other objects and advantages which become subsequently apparent, reside in the details of the construction and operation of the system herein as more fully hereinafter described and claimed, reference being had to the accompanying drawings forming a part thereof, wherein like numerals refer to like parts throughout.

Further objectives of this invention will be ascertained by those skilled in the art as brought out in the following part of the specification wherein detailed description is for the purpose of fully disclosing the invention without placing limitations thereon.

### BRIEF DESCRIPTION OF DRAWING FIGURE

FIG. 1 depicts a rear perspective view of the folding camper device herein showing it in the collapsed position wherein the roof and sidewalls are folded to horizontal positions.

FIG. 2 shows the camper device herein, wherein actuators engaged between the roof and body have been powered to project a rod to extend from a housing to an extended position and thereby raise the roof and sidewalls automatically.

FIG. 3 depicts the rear end of the camper device of FIG. 1 and FIG. 5 moving from a collapsed configuration to the deployed configuration by raising the roof and sidewalls.

FIG. 3A shows the front end or cab side of the camper device of FIG. 1 moving from a collapsed configuration to the deployed configuration.

FIG. 4 shows the device, as in FIG. 1, wherein the actuators have raised the roof to cause the sidewalls to also rise to a vertical disposition.

FIG. 5 shows another mode of the camper device wherein members connected between the roof and sidewalls cause the sidewalls to rotate to the vertical position as the roof is raised by the actuators.

FIG. 6 shows the elongated members pulling a sidewall to the vertical position as the roof is raised by the actuators.

FIG. 7 depicts a lock which engages the raised sidewalls to hold them elevated and shows a cable release allowing the user to disengage the lock before powering the actuators to pull the camper to the collapsed position, such as in FIG. 1.

### DETAILED DESCRIPTION OF THE PREFERRED EMBODIMENTS OF THE INVENTION

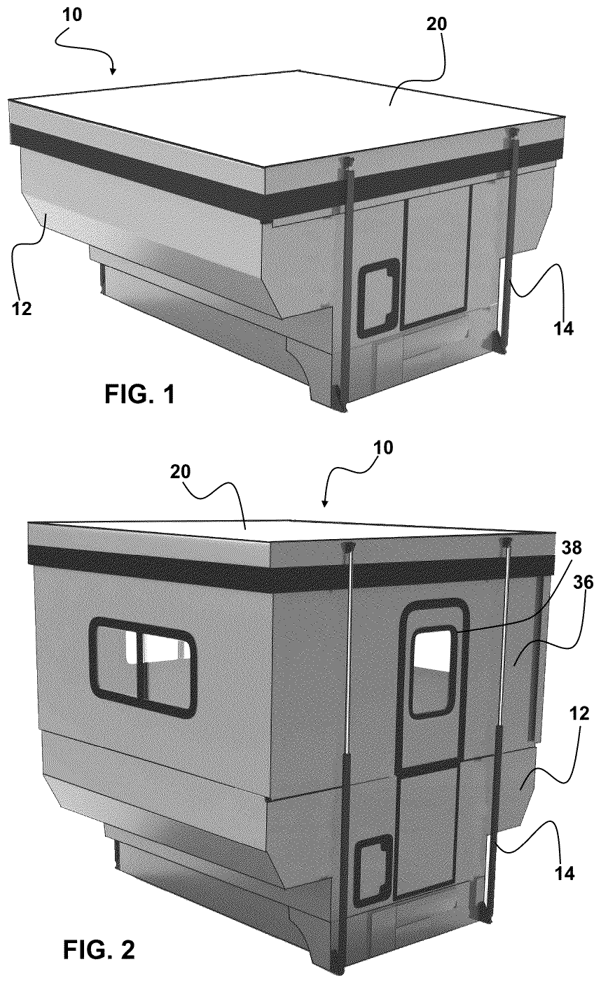

Referring now to the device 10 herein in the depictions of FIGS. 1-7, there is seen in FIG. 1 a rear perspective view of the folding camper system 10 herein. The body 12 has a lower portion which is configured for positioning within the open area of the bed of a pickup truck or the like or upon a trailer adapted to hold it.

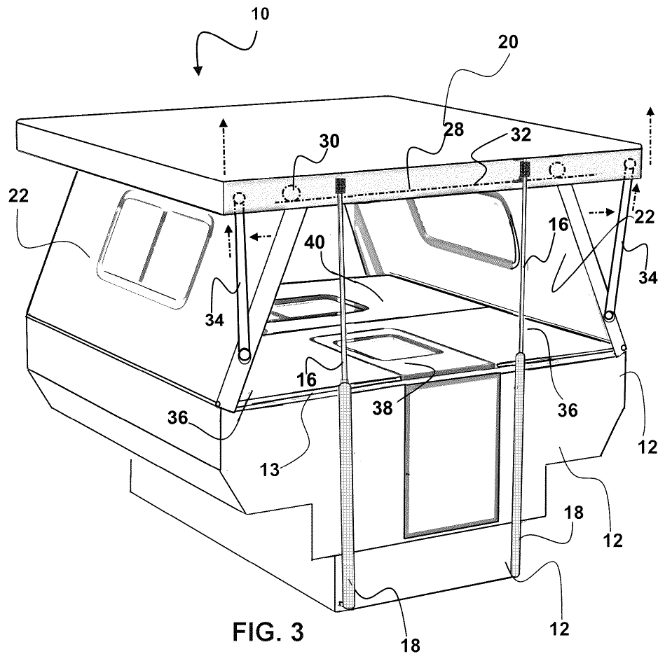

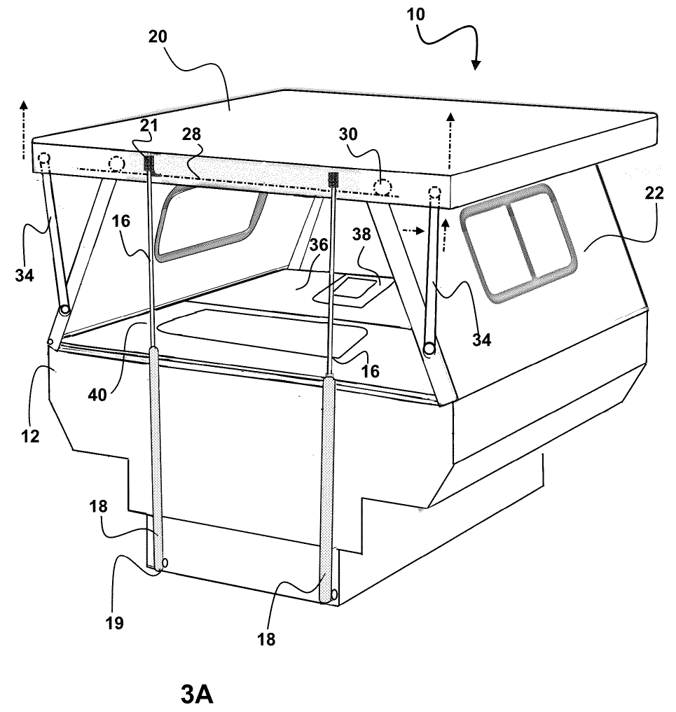

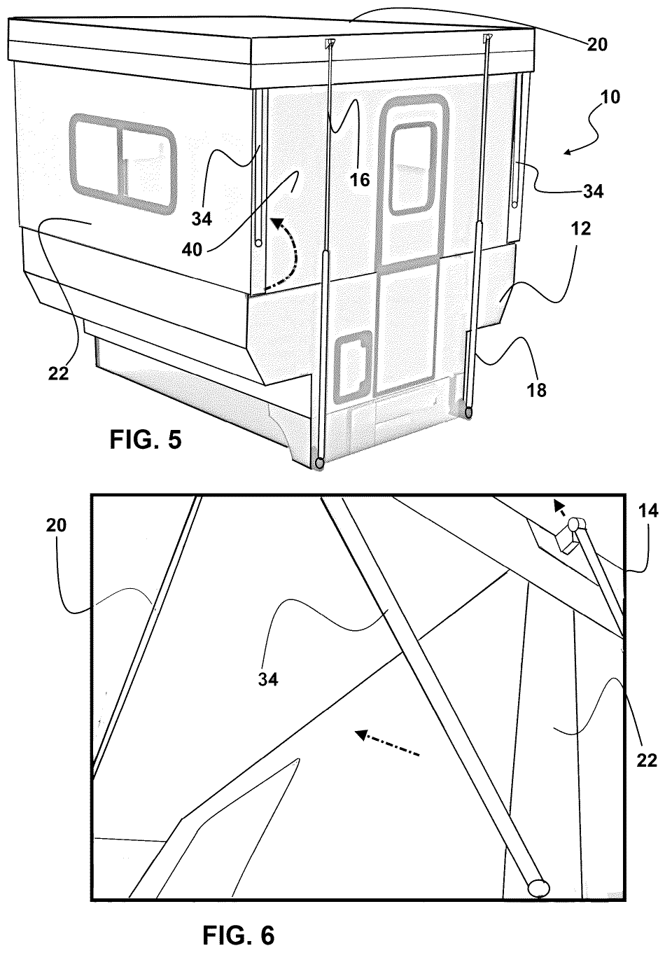

The device 10 moves from a collapsed configuration, as in FIG. 1, to a deployed position or configuration, as in FIGS. 2 and 5. Powered actuators 14 are positioned, at least on the rear, shown in FIG. 2, and are preferably also positioned on the opposite side of the body 12, as in FIG. 3A, to provide a powered means for moving the device 10 between the collapsed configuration to the deployed position. This makes it easy for the user to use a switch or remote control to energize the actuators 14 to translate the rod 16 into and out of the cylinder 18.

Such actuators may be hydraulicly powered, using a pump, or in a particularly preferred mode, may be electrically powered using an internal electric motor engaged to the cylinder 18 to translate the rod 16 into an extended from the cylinder 18, such as with a worm gear configuration. Where the actuator 14 is electric, it can be operatively engaged to the power of the vehicle to which the device is engaged, or it can be engaged to an onboard battery positioned in the body 12 which can provide electric power. A power switch, while not shown, is well known and can be operatively connected to the actuators to cause them to elongate and contract.

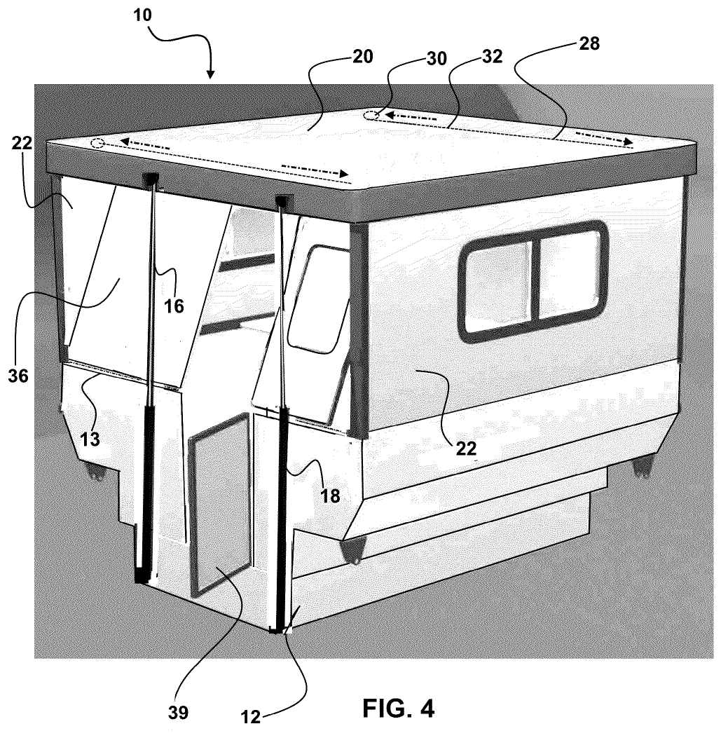

One end, shown as the cylinder end, is engaged to the body 12. An opposite end at the distal end of the rod 16 is connected to the roof 20, preferably in rotating connections 21, to allow movement during use. In the collapsed configuration of FIG. 1, the rod 16 has been drawn into the interior of the cylinder 18. In the deployed or expanded positions of FIGS. 2 and 4, the actuator has translated the rod 16 to an extended position projecting from the cylinder 18. This translation to the extended position causes the roof 20 to move upward and away from the body 12, such as shown in FIG. 3.

As shown in FIG. 3, which is a rear view of the device 10 and FIG. 3A, which is the end closest to the cab of the truck, the actuators 14 have been energized to elongate such as to force the rod 16 out of the cylinder 18. As the rods 16 on all four cylinders 18 are forced upward in their connections to the roof 20, the translation of the rods 16 forces the roof 20 to move away from the body 12. During this raising of the roof 20, the opposing sidewalls 22 are slidably connected to the roof 20, such as with a wheel 30 and track 32 system. This sliding engagement allows the opposing sidewalls 22 to rotate in their rotational engagement to the body and to fold upward as the roof 20 is raised to a vertical position, as in FIGS. 2 and 5.

In addition to the sliding engagement being employed to pull the sidewalls 22 to a vertical position, members 34 may be connected in rotational engagements with the roof 20 and the sidewalls 22. The members 34 can impart force to the sidewalls 22 to which they are rotationally connected as the roof 20 is forced upward by the force of the enlarging actuators, such as where the rod 16 is being forced from the hydraulic or pneumatic cylinders 18. The members 34, so positioned, will pull the sidewalls 22 from the lowered position to the vertical position, as the roof 20 is raised.

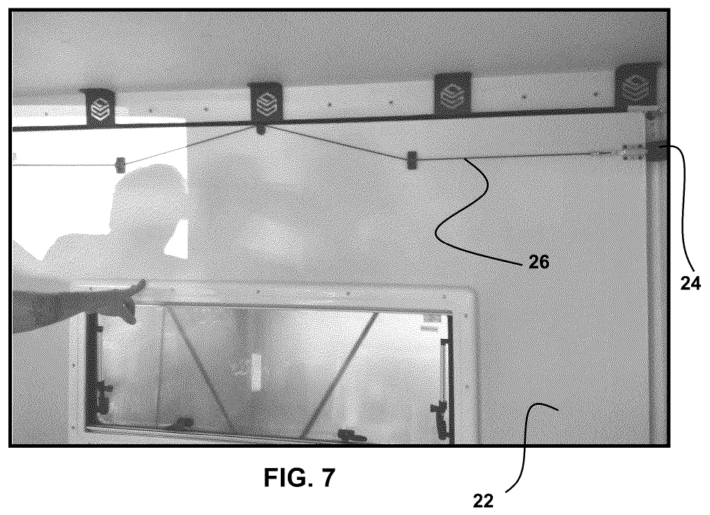

Once in the vertical position, as in FIG. 7, the user may lock each of the front wall 40 and rear wall 36 to the adjacent sidewalls 22 or to an interior edge of the roof 20 to to maintain the front wall 40 and rear wall 36 in the vertical position, during use of the camping device 10. As shown in FIG. 7, a cable 26 engaged to the pair of locks 24, which have biased lock members, will release locks 24 on each end of the cable 24 (one shown but second would be in the same positioning) from such locked engagement with the two sidewalls 22 or the roof 20, when the user wishes to employ the actuators 14 to collapse the camping device 10. This cable 26 and pair of locks 24 on each end may be positioned on both the front wall 40 and rear wall 36 to hold them in the vertical positioning when the roof 20 has been raised and the sidewalls 22 have been rotated to vertical positions. This cable 26 configuration is currently preferred as it allows the user an easy manner to lean into the interior cavity of the device 10 while in the deployed position or configuration of FIG. 2 and to pull on the cable 26 to overcome the biased engagement of the lock member and thereby release the locks 24 to allow it to move to the collapsed configuration.

As noted, the sliding engagement of the roof 20 to the sidewalls 22 at the upper end of each sidewall 22 will cause movement of the roof 20 to concurrently move the sidewalls 22 upward. Where the members 34 are included to pull the sidewalls 22 upward, the sliding engagement of the sidewalls 22 to the roof 20 will allow the sidewall 22 to rotate to the vertical position as the roof 20 pulls on the members 34 to force them upward. As the actuators 14 are powered to raise the roof 20 to the elevated position, the engaged members 34 will concurrently pull the sidewalls 22 to the elevated position of FIGS. 2 and 5.

To lower the roof 20 and sidewalls 22, once the lock 24 has been released from a respective engagement to a sidewall 22, as the actuators 14 are powered or configured to retract the rod 16 and thereby pull the roof 20 to the collapsed configuration, the members 34 will rotate and allow the sidewalls 22 to move to the horizontal positioning, so the device 10 can move to the collapsed configuration.

In all modes of the device 10 herein, once the roof 20 has been forced or biased to the elevated position of FIGS. 4-5, a rear wall 36 in a hinged 13 engagement to the body 12 having an upper door portion 38, can be rotated to a vertical position, such as in FIG. 2 and locked in a similar manner to this upright position. A lower door 39 portion is positioned on the fixed portion of a lower rear wall. A front wall 40, as in FIG. 3, will also be in a hinged engagement and thereby can be tilted to a vertical position once the device 10 is in the deployed position.

As noted, in all modes of the camper device 10 herein, the user will have a remote control or other switch to allow them to energize the actuators 14 to either translate the rod 16 outward to deploy the camper or to translate the rod 16 into the cylinder 18 to thereby easily move the device to the collapsed position.

While all of the fundamental characteristics and features of the pickup truck engageable, folding camper system, have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A folding camper, comprising:
a body, said body having a lower end configured for positioning within a bed of a pickup truck or on a trailer;
said body having a perimeter edge communicating around sides of said body at an upper end thereof opposite said lower end;
a first sidewall having a lower end thereof rotationally engaged to said upper end of said body;
a second sidewall having a lower end thereof rotationally engaged to said upper end of said body opposite said first sidewall;
a front wall, said front wall having a lower end thereof rotationally engaged to said upper end of said body in between said first sidewall and said second sidewall;
a rear wall, said rear wall having a lower end thereof rotationally engaged to said body on a side of said body opposite said front wall;
a roof;
a top end of said first sidewall in a first sliding engagement thereof with said roof;
a top end of said second sidewall in second sliding engagement thereof, with said roof;
said folding camper having a collapsed configuration wherein said first sidewall and said second sidewall and said front wall and said rear wall are all in respective folded positions in a substantially horizontal positioning adjacent to and under said roof;
actuators engaged between said body and said roof;
said actuators moveable to elongate from a collapsed configuration thereof to an elongated configuration thereof;
said actuators moving to said elongated position moving said roof to a deployed position elevated above said perimeter edge of said body; and
said first sidewall and said second sidewall rotating from said folded position thereof to respective vertical positions thereof, as said roof moves to said deployed position, whereby said folding camper is in a deployed position.

2. The folding camper of claim 1 additionally comprising:
a first pair of members rotationally engaged at first ends thereof, to opposite ends of said first sidewall;
said first pair of members rotationally engaged at second ends thereof to opposite ends of said roof;
a second pair of members rotationally engaged at first ends thereof to opposite ends of said second sidewall;
said second pair of members rotationally engaged at second ends thereof to opposite ends of said roof;
said first pair of members for imparting an upward force from said roof to said first sidewall to rotate said first sidewall to said vertical position; and
said second pair of members for imparting said upward force to said second sidewall to rotate said second sidewall to said vertical position.

3. The folding camper of claim 1 additionally comprising:
said front wall rotatable to a vertical positioning thereof substantially perpendicular to said first sidewall and said second sidewall only when said roof is in said deployed position; and
said rear wall rotatable to a vertical positioning thereof substantially perpendicular to said first sidewall and said second sidewall only when said roof is in said deployed position.

4. The folding camper of claim 2 additionally comprising:
said front wall rotatable to a vertical positioning thereof substantially perpendicular to said first sidewall and said second sidewall only when said roof is in said deployed position; and
said rear wall rotatable to a vertical positioning thereof substantially perpendicular to said first sidewall and said second sidewall only when said roof is in said deployed position.

5. The folding camper of claim 3 additionally comprising:
a first pair of locks engageable on opposing sides of said front wall, said first pair of locks engageable to first locked connections with both said sidewalls with said front wall in said vertical positioning;
a first cable connected to said first pair of locks, said first cable positioned for pulling to release said first locked connections;
a second pair of locks engageable on opposing sides of said rear wall, said second pair of locks engageable to second locked connections with both said sidewalls with said rear wall in said vertical positioning; and
a second cable connected to said second pair of locks, said second cable positioned for pulling to release said second locked connection.

6. The folding camper of claim 4 additionally comprising:
a first pair of locks engageable on opposing sides of said front wall, said first pair of locks engageable to first locked connections with both said sidewalls with said front wall in said vertical positioning;
a first cable connected to said first pair of locks, said first cable positioned for pulling to release said first locked connections;
a second pair of locks engageable on opposing sides of said rear wall, said second pair of locks engageable to second locked connections with both said sidewalls with said rear wall in said vertical positioning; and
a second cable connected to said second pair of locks, said second cable positioned for pulling to release said second locked connection.

7. The folding camper of claim 1 wherein said actuators are one of a group of actuators including a hydraulic powered cylinder engaged with an extendable rod, an electrically powered cylinder having an extendable rod engaged therewith, or a pneumatic powered cylinder having an extendable rod engaged therewith.

8. The folding camper of claim 2 wherein said actuators are one of a group of actuators including a hydraulic powered cylinder engaged with an extendable rod, an electrically powered cylinder having an extendable rod engaged therewith, or a pneumatic powered cylinder having an extendable rod engaged therewith.

9. The folding camper of claim 3 wherein said actuators are one of a group of actuators including a hydraulic powered cylinder engaged with an extendable rod, an electrically powered cylinder having an extendable rod engaged therewith, or a pneumatic powered cylinder having an extendable rod engaged therewith.

10. The folding camper of claim 4 wherein said actuators are one of a group of actuators including a hydraulic powered cylinder engaged with an extendable rod, an electrically powered cylinder having an extendable rod engaged therewith, or a pneumatic powered cylinder having an extendable rod engaged therewith.

11. The folding camper of claim 5 wherein said actuators are one of a group of actuators including a hydraulic powered cylinder engaged with an extendable rod, an electrically powered cylinder having an extendable rod engaged therewith, or a pneumatic powered cylinder having an extendable rod engaged therewith.

12. The folding camper of claim 6 wherein said actuators are one of a group of actuators including a hydraulic powered cylinder engaged with an extendable rod, an electrically powered cylinder having an extendable rod engaged therewith, or a pneumatic powered cylinder having an extendable rod engaged therewith.
